(19) United States
(12) Patent Application Publication
(10) Pub. No.: US 2025/0289582 A1
(43) Pub. Date: Sep. 18, 2025

(54) GAS SUPPLY FOR AIRCRAFT APPLICATIONS

(71) Applicant: Airbus Operations Limited, Bristol (GB)

(72) Inventor: Henry Edwards, Bristol (GB)

(21) Appl. No.: 19/080,161

(22) Filed: Mar. 14, 2025

(30) Foreign Application Priority Data
Mar. 18, 2024 (GB) 2403870.5

(51) Int. Cl. B64D 37/32; B64F 1/28

(52) U.S. Cl. CPC B64D 37/32; B64F 1/28

(57) ABSTRACT

A fuel line terminating in a refuel connector is used to fuel or defuel an aircraft, for example with liquid hydrogen. A supply of nitrogen housed on an aircraft, for example a Nitrogen Generating System, is used in conjunction with a gas line to supply nitrogen into the fuel line, to flush out potentially combustible materials before liquid hydrogen is supplied through the fuel line. The aircraft supply of nitrogen is also used to supply inert gas, via a gas line, to the Ground Support Equipment refuelling or defuelling the aircraft. This can provide redundancy for the Ground Support Equipment's systems, and may allow the aircraft to operate at less well-equipped airports.

### TECHNICAL FIELD

The present disclosure relates to an apparatus and method for supplying gas, for example inerting gas, to, in particular, aircraft Ground Support Equipment (GSE), for example during a process of refuelling an aircraft (and/or defuelling an aircraft). More particularly, but not exclusively, this disclosure concerns an apparatus and method for protecting against ignition of vaporized hydrogen in the event of a hydrogen leak during a refuelling/defuelling process for an aircraft that is configured to use hydrogen as a fuel.

### BACKGROUND

Hydrogen has been identified as a potentially environmentally preferable alternative to traditional fossil fuels, such as kerosene, in use as a fuel source for aircraft. Some aviation technologies and operations may require relatively minor adjustments to utilize hydrogen, whereas some will require significant alterations. The fuel supply and storage system is one of the latter, due to the considerably different requirements and characteristics of hydrogen in comparison to traditional jet fuels.

Traditional kerosene refuelling and defuelling technology is not suitable for hydrogen refuelling for a variety of reasons. At atmospheric pressure, hydrogen must be stored at temperatures of 20K or less to be stored as a liquid. A kerosene fuel line does not have sufficient insulation to carry liquid hydrogen at this temperature, and the materials used in such a kerosene fuel line might not be able to withstand such low temperatures.

Additionally, hydrogen is a highly flammable substance, with an ignition energy (that being the energy required to cause a substance to ignite) significantly lower than kerosene. Hydrogen also has a large range of concentrations in atmospheric air for which ignition can occur. Hydrogen leaks occurring during refuelling or defuelling may be difficult to eliminate entirely. Current safety measures in place for preventing ignition of kerosene during a refuelling or defuelling process may be inadequate for preventing ignition of hydrogen.

Aircraft refuelling is traditionally performed by a refuel bowser, which uplifts fuel from an airport supply to the aircraft, or a tanker, which contains fuel to be uplifted to the aircraft. Hydrogen refuelling/defuelling will likely utilize an airport supply, due to the potential for more efficient storage. In the case of hydrogen powered aircraft, it is also likely that hydrogen will need to be defuelled from the aircraft, that is retrieving hydrogen from the aircraft, for example for storage in fuel storage facilities off the aircraft if the aircraft is not operating and not likely to be needed for operation for several hours at least.

In all of these cases, the GSE will be handling large quantities of liquid hydrogen, and therefore it is very important that adequate provisions are put in place to protect the GSE against inadvertent ignition of the fuel.

Due to the quantities of liquid hydrogen involved in this application, ignition during a refuelling process could cause injury to people handling the equipment, as well as damage to the GSE and aircraft. Given the potential severity of this risk, it is preferable that any provisions put in place to prevent this have a level of redundancy. Additionally, given the importance of an inerting system, it would be preferable that such a system is readily available to the aircraft/GSE at all times.

It may also be important that these provisions are capable of helping to protect both internal and external parts of the aircraft/GSE. For example, the inside of the fuel line will have liquid hydrogen passing through, and areas around the refuel infrastructure may experience a leak of hydrogen.

The disclosure herein seeks to mitigate one or more of the above-mentioned problems. Alternatively or additionally, the disclosure herein seeks to provide an improved apparatus and method of refuelling and defuelling an aircraft, that can for example be used to refuel and defuel an aircraft with liquid hydrogen while mitigating the risk of the hydrogen igniting around the GSE in the event of a leak.

### SUMMARY

The disclosure herein provides, according to a first aspect, an apparatus for supplying gas from an aircraft to ground equipment. The apparatus comprises a gas supply housed within the aircraft. The apparatus also comprises at least one gas line configured to establish fluid communication between the gas supply and the ground equipment. Embodiments of the disclosure herein may be configured to protect against ignition in the event of a fuel leak in the region of the GSE. Embodiments of the disclosure herein may be configured to utilize pre-existing aircraft infrastructure to inert areas through which fuel will pass. For example, in use, before fuel is supplied by a fuel line to an aircraft fuel tank, possibly via pipework within the aircraft (the fuel line being connected via the refuel connector to the aircraft on the ground), inert gas is pumped from the aircraft through the fuel line to flush out any combustible elements which may be present, for example oxygen in atmospheric air which may enter after performing a refuelling/defuelling operation. For a further example, when fuel is being supplied by the fuel line to an aircraft fuel tank, inert gas is pumped from the aircraft through a gas line to outlets associated with the ground equipment to inert the surrounding area in case of a leak.

The gas supply may be a store of gas configured to retain and release gas on command. The gas line may be a flexible tube. Ground equipment may be any equipment being used in the vicinity of the aircraft. For example, the ground equipment may be a form of GSE, for example GSE which handles fuel.

The gas within the gas supply on the aircraft may be inert gas (for example a gas that is used for inerting purposes in an aircraft or GSE application or related purpose). The gas within the gas supply on the aircraft may be generated by a component on the aircraft. The gas supply on the aircraft may be a gas-generating component. Alternatively or additionally, a gas generating component may generate gas to be stored in the gas supply. Such options may allow for the aircraft always to have a supply of gas readily available. This may reduce a dependence on ground equipment and airports having their own integrated inerting systems. This may facilitate utilization of smaller and less well-equipped airports.

The inert gas may be nitrogen (e.g. >95% purity, optionally >99% purity N₂, and/or may consist of NEA=“Nitrogen Enriched Air”). The gas-generating component on the aircraft may be a nitrogen generation system, for example an aircraft NGS (Nitrogen Generation System—i.e. a nitrogen generation system configured for use on/in an aircraft. The NGS may be a pre-existing component on the aircraft. This may prevent added weight and improve utilization of onboard components.

The at least one gas line configured to establish fluid communication between the gas supply and the ground equipment may have several potential configurations, and may—or may not—comprise gas lines which are separate or independent from another. There may be the same gas line utilized for multiple purposes.

At least one gas line may be configured to establish fluid communication upon connection of a fuel line to the aircraft. Such a gas line may be a gas line on the aircraft (e.g. a pre-existing gas line). The gas line may connect to a gas line connector disposed in the vicinity of a fuel port on the aircraft. The gas line connector may be integrated into the fuel port.

The fuel line (for example the fuel line connecting an external supply of fuel to the aircraft) may be a metal pipe. The fuel line may be configured for supplying cryogenic hydrogen. The fuel line may be tubular. The fuel line may be flexible, for example via one or more joints, to increase ease of use. The fuel line may be circumferentially surrounded by insulation. The fuel line may be insulated using vacuum insulation. Such vacuum insulation may for example take the form where a near-vacuum is created between the surface of the item being insulated, and a second surface disposed a distance from the first surface. This significantly reduces heat transfer by convection and conduction. The fuel line may terminate in a refuel connector. The fuel line may be a part of a fuel line structure, that may for example include other parts or apparatus associated with the fuel line, such as the insulation. For example, the combination of the fuel line, refuel connector, and insulation, may be considered as a fuel line structure. The fuel line structure may integrate passageways for the flow of inert gas, for example to and/or from (or incorporating at least a part of) the at least one gas line.

The refuel connector may connect to the fuel port on the aircraft. The refuel connector may comprise a gas line connector corresponding to a gas line connector associated with the fuel port. The two gas line connectors may connect to establish fluid communication between a first portion of the gas line and a second portion of the gas line (e.g. the second portion of the gas line being associated with the fuel line). An example of the connection of two gas lines through a refuel connector and fuel port is described and claimed in UK patent application entitled “AIRCRAFT REFUELLING/DEFUELLING SYSTEM” with agent's reference “P038509GB”. The contents of that application are fully incorporated herein by reference. The claims of the present application may incorporate any of the features disclosed in that patent application. It will be appreciated that the connection of the two gas line connectors is not limited to the form disclosed in the above referenced application.

The at least one gas line may comprise at least one outlet. There may be multiple gas outlets. Such an outlet may be configured to distribute gas, for example for the purpose of inerting a region or space. The outlet may be referred to as an inerting outlet (in other words, an outlet for supplying inert gas used for the purpose of fire suppression/prevention, ignition prevention or otherwise inerting a region or space with inert gas). Such an outlet may comprise a nozzle. A single gas line may have at least 1 outlet, for example at least 3 outlets, for example at least 6 outlets, for example at least 10 outlets.

One or more outlets of a gas line may be disposed within a fuel line connected between the ground equipment and the aircraft. The at least one gas line may comprise a line which runs parallel to at least a part of the fuel line. There may be several outlets directed to disperse gas within the fuel line. This may improve the flow and dispersion of gas within the fuel line. The outlets may be spaced along the longitudinal length of the fuel line. The gas line may run externally to the fuel line, but internally of the outer surface of a fuel line structure which incorporates the fuel line and gas line. This may protect the gas line associated with the fuel line, and may simplify setup of the apparatus.

In some embodiments, there may be a gas line, or at least a part thereof, that runs externally of the fuel line structure.

The gas line may have an outlet disposed about a refuel port such that when a refuel connector is connected, the outlet is directed such that gas leaving the outlet passes into the fuel line. The gas line may furcate such that it has both an outlet configured to disperse gas into the fuel line and a further outlet or output. Such a further outlet may for example terminate in a gas line connector associated with the fuel port. There may be a valve to open/close the outlet disposed to disperse gas into the fuel line. This may prevent unwanted flow of liquid hydrogen into the outlet.

The above apparatus may allow for gas to be supplied from the aircraft directly into the fuel line. The fuel line may comprise a further outlet downstream (in the direction of normal flow of gas in operation) of the gas line outlet, the further outlet being configurable between an open and closed configuration. This may allow for the ejection of gas present in the fuel line. Therefore, gas may be pumped from the aircraft through the fuel line without causing a build-up of pressure or leaving an excess of gas within the fuel line. This may also allow for combustible or other undesired elements which may be present within the fuel line to be flushed out and replaced with gas from the gas supply on the aircraft. There may be a gas outlet positioned to supply inert gas into a relevant area. There may be multiple outlets along the fuel line for this purpose.

There may be more than one gas line configured to establish fluid communication between the aircraft and the ground equipment. Such a further gas line may be a furcated line from an upstream gas line. Alternatively or additionally, such a further gas line may be a separate gas line connected to the aircraft supply of gas. At least one gas line may be configured for storage on the aircraft and deployed for use. At least one gas line may be connected to the aircraft.

At least one gas line may be connected to, or form part of, a gas line on the ground equipment. For example such a gas line may be connected at one end to a store of gas on the ground equipment. This ground equipment store of gas may store inert gas, for example nitrogen. At least one gas line may be disposed on the outside of the ground equipment. At least one outlet of any gas line may be disposed in the vicinity of the ground equipment. This outlet may be configured to disperse gas around relevant areas of the ground equipment. At least one outlet of a gas line may be disposed in the vicinity of an airport store of fuel. This store of fuel may be located on the ground equipment. Alternatively, this store of fuel may be a reservoir in the airport which is pumped to the aircraft.

There may be at least one valve on any of the gas lines mentioned herein configured to controllably prevent or permit the passage of gas through the gas line. This may allow gas to be dispersed through specific gas lines and not others depending on the requirements and situation. For example, while hydrogen is being passed through the fuel line, it may be undesirable to disperse inert gas into the fuel line, but it may be desirable to disperse inert gas through outlets arranged around the ground equipment.

It may be that at least one outlet of any gas line connected to the gas supply housed within the aircraft is disposed in the vicinity of a refuel connector where the refuel connector provides a fuel connection at the aircraft, for example at a refuel port of the aircraft. This may help inert the area around the refuel port during refuelling/defuelling. An example of inerting of a specific region, for example a refuel connector and fuel port is described and claimed in UK patent applications entitled “AIRCRAFT REFUELLING/DEFUELLING SYSTEM” with agent's reference “P038509GB” and “REFUELLING/DEFUELLING AN AIRCRAFT” with agent's reference “P038381GB”. The contents of those applications are fully incorporated herein by reference. The claims of the present application may incorporate any of the features disclosed in those patent applications.

It will be understood that a gas line in the context of the disclosure herein may comprise several gas lines connected together. For example, the gas line on the aircraft may comprise a network of gas lines dispensing gas to several locations, for example including at least one valve, a manifold, and/or one or more outlets.

The ground equipment may be configured to supply hydrogen, e.g. liquid hydrogen, to the aircraft. The ground equipment may be a refuel/defuel bowser. The ground equipment may be a refuel/defuel tanker.

According to a further aspect of the disclosure herein there is provided a method of refuelling/defuelling an aircraft fuelled with liquid hydrogen. The method may be performed with the apparatus of any aspect of the disclosure herein as described or claimed herein. The method comprises supplying inert gas from the aircraft to a GSE via a fuel line. For example, inert gas may be supplied via the fuel line along at least some of the same passageways via which fuel flows during the refuelling/defuelling of the aircraft. The method also comprises supplying liquid hydrogen to/from the aircraft from/to the GSE via the same fuel line. Preferably, the step of supplying inert gas is performed before the step of supplying liquid hydrogen. This flushes out potential combustible materials present within the fuel line prior to passing the liquid hydrogen through.

The inert gas may be generated by a system on the aircraft, for example a nitrogen generating system. This may increase the aircraft's independence for inerting and may alleviate weight concerns from adding additional items. The inert gas may be nitrogen.

According to a further aspect of the disclosure herein, there is provided a method of protecting against ignition of fuel. The method may be performed with the apparatus of any aspect of the disclosure herein as described or claimed herein, or may incorporate the method of any aspect of the disclosure herein as described or claimed herein. This method comprises generating inert gas on an aircraft. The method further comprises supplying the inert gas from the aircraft to GSE. The method further comprises distributing inert gas out of at least one outlet, the outlet being arranged to direct the inert gas into the vicinity of the GSE. This method may be performed during a refuelling/defuelling process. The inert gas may be nitrogen. The fuel may be liquid hydrogen.

The inert gas may be supplied to the GSE via a gas line. This gas line may be stored on the aircraft. This may reduce the aircraft's reliance on airports.

The gas line may form part of, or be attached to, or integrated with, a part of the fuel line. The fuel line may include at least part of the gas line.

This aspect may be used as part of a method of protecting GSE against ignition of fuel. The method may comprise supplying inert gas from a supply of inert gas separate to that housed on the aircraft into the vicinity of the GSE. In the event of failure of this inert gas supply, the method of this aspect may be implemented to protect against ignition of fuel. This may provide a backup system to the GSE. As mentioned above, the fuel may be hydrogen, supplied as liquid hydrogen for example.

According to a further aspect of the disclosure herein, there is provided a method of protecting against ignition of hydrogen during a refuelling/defuelling process. The method comprises refuelling/defuelling the aircraft according to any aspect of the disclosure herein described or claimed herein. The method further comprises, during the step of supplying liquid hydrogen to/from the aircraft from/to the GSE, protecting against ignition of hydrogen fuel according to any aspect of the disclosure herein described or claimed herein.

According to a further aspect of the disclosure herein, there is provided an aircraft (for example at an airport) incorporating an apparatus according to any aspect of the disclosure herein described or claimed herein and/or being configured for use in a method according to any aspect of the disclosure herein described or claimed herein. The aircraft comprises a supply of inert gas housed within the aircraft. The aircraft may comprise a system for generating inert gas for the supply of inert gas. The supply of inert gas may have a first purpose within a system on the aircraft. There may be a port at the exterior of the aircraft for connecting a gas line to the port for the purpose of transporting the inert gas from the gas supply on the aircraft to an item of GSE, for a second purpose (i.e. in accordance with the aspects of the disclosure herein as described or claimed herein).

According to a further aspect of the disclosure herein, there is provided a refuelling/defuelling system for a hydrogen-powered aircraft. The system comprises a fuel line for supplying cryogenic hydrogen to the aircraft. The system further comprises a supply of inert gas housed within the aircraft. The system further comprises a gas line establishing fluid communication between the supply of inert gas and a plurality of inert gas outlets associated with an item of GSE, such that in use inert gas is supplied from the aircraft to the outlets. The aircraft may have a hydrogen-based power source as a primary source of power or as a secondary source of power. The main propulsion of the aircraft may be powered by hydrogen as its primary source of fuel. The aircraft may comprise one or more (preferably many) hydrogen fuel cells. The aircraft may have other sources of power alongside hydrogen-based power generation systems.

According to certain embodiments of the disclosure herein, there is provided an aircraft and an item of GSE, wherein the item of GSE uses inert gas for a function (e.g. for the purpose of inerting a space or region) of the GSE, and wherein the primary source of the inert gas is from a supply of inert gas on the aircraft via a disconnectable gas line that extends from the aircraft to the GSE. According to certain other embodiments of the disclosure herein, there is provided an aircraft and an item of GSE, wherein the item of GSE uses inert gas for a function of the GSE, the primary source of the inert gas being from a supply that is independent of the aircraft (e.g. the GSE has its own source of inert gas), wherein redundancy is provided via a supply of inert gas on the aircraft via a disconnectable gas line that extends from the aircraft to the GSE. The function of the GSE that uses inert gas may be related to fire prevention, fire suppression, protecting against ignition of fuel or the like.

The aircraft may be a passenger aircraft. The passenger aircraft preferably comprises a passenger cabin comprising a plurality of rows and columns of seat units for accommodating a multiplicity of passengers. The aircraft may have a capacity of at least 20, more preferably at least 50 passengers, and optionally more than 75 passengers. The aircraft may be a commercial aircraft, for example a commercial passenger aircraft, for example a single aisle or twin aisle aircraft. The aircraft need not be configured for carrying passengers, but could for example be an aircraft of an equivalent size configured for cargo and/or used on a non-commercial basis. The aircraft may have a maximum take-off weight (MTOW) of at least 20 tonnes, optionally at least 40 tonnes, and possibly 50 tonnes or more. The aircraft may have an operating empty weight of at least 20 tonnes, optionally at least 30 tonnes, and possibly about 40 tonnes or more.

It will of course be appreciated that features described in relation to one aspect of the disclosure herein may be incorporated into other aspects of the disclosure herein. For example, the method of the disclosure herein may incorporate any of the features described with reference to the apparatus of the disclosure herein and vice versa.

### BRIEF DESCRIPTION OF THE DRAWINGS

Embodiments of the disclosure herein will now be described by way of example only with reference to the accompanying schematic drawings of which:

FIG. 1 shows a front view of an aircraft being refuelled and/or defuelled by a refuelling bowser;

FIG. 2 shows an example aircraft refuelling/defuelling apparatus for background information;

FIG. 3 shows an aircraft refuelling/defuelling apparatus with the use of a first embodiment of the disclosure herein;

FIG. 4 shows an aircraft refuelling/defuelling apparatus with the use of a second embodiment of the disclosure herein;

FIG. 5 shows an aircraft refuelling/defuelling apparatus with the use of a third embodiment of the disclosure herein;

FIG. 6 shows a method of refuelling/defuelling an aircraft according to a fourth embodiment of the disclosure herein; and

FIG. 7 shows a method of refuelling/defuelling an aircraft according to a fifth embodiment of the disclosure herein.

### DETAILED DESCRIPTION

Embodiments of the disclosure herein relate to an ignition protection system for a ground-based refuelling and defuelling system for an aircraft, in particular when refuelling and defuelling an aircraft with liquid hydrogen. In use of the embodiments, inert gas is generated on the aircraft and is supplied, via a connection, to GSE. The supply of inert gas reduces the risk of ignition of hydrogen gas during the refuelling and defuelling operations.

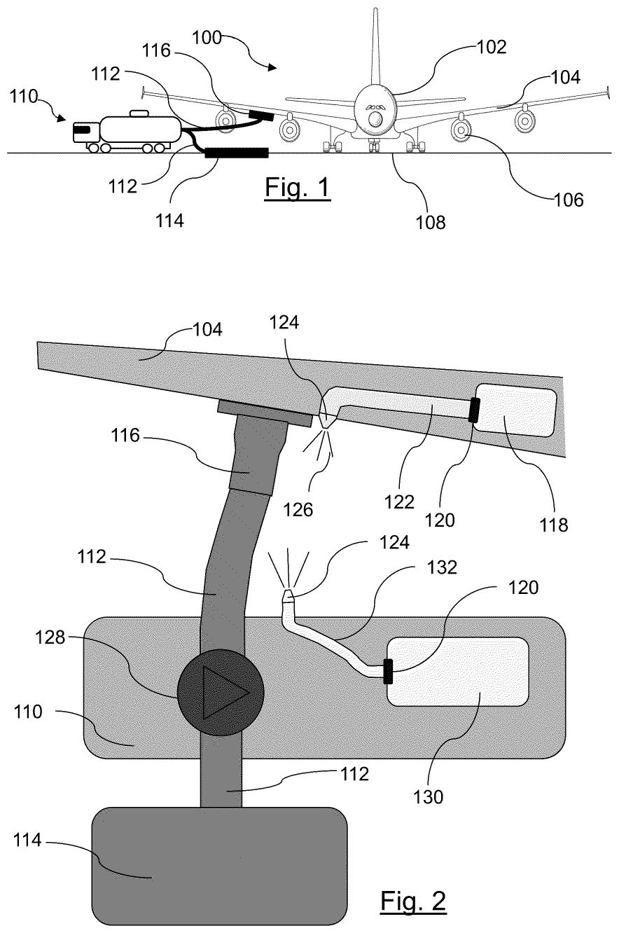

FIG. 1 shows a hydrogen-powered aircraft 100 comprising a fuselage 102, wings 104, and engines 106, located on the ground 108, being refuelled by GSE 110 via a fuel line 112. The GSE 110 uplifts liquid hydrogen fuel (stored cryogenically) from a central fuel store 114 in the airport to the aircraft 100. The fuel line 112 connects to the aircraft via a refuel connector 116. This refuel connector 116 is configured to connect and lock to an aircraft fuel port located on the underside of the aircraft wing 104. The fuel is supplied to a tank system in the aircraft, the tanks of which may be housed in the wings 104 and/or in the fuselage 102 for example. A supply of inert gas (not visible) is also present within the aircraft 100, and may be housed in the wings 104 and/or in the fuselage 102 for example.

FIG. 2 shows a proposed apparatus for refuelling and defuelling an aircraft with liquid hydrogen (not of the prior art) for background information, without the use of any of the illustrated embodiments of the disclosure herein. As can be seen, there is a pre-existing Nitrogen Generating System (NGS) 118 housed within the wing 104 of the aircraft. The NGS 118 is connected via a valve 120 to an aircraft gas line 122. The aircraft gas line terminates in a nozzle 124. Nitrogen (or NEA), indicated by lines 126, is distributed out of the nozzle 124 into the vicinity of the refuel connector 116. It will be appreciated that there may be many aircraft gas lines 122 and respective nozzles 124 spraying around the refuel connector 116, but only one is illustrated here for clarity.

In the defuelling case, hydrogen in liquid and gas form is pumped by pump 128 from the aircraft 100, through the refuel connector 116, down the fuel line 112, and into a fuel store 114 located at the airport. The pump 128 is located on GSE 110, which in this case is a refuel/defuel bowser. However, it will be appreciated that the GSE could also be a refuel/defuel tanker which has an on-board fuel tank for storing fuel going to/from the aircraft 100.

The GSE 110 also has a supply of nitrogen 130. This supply 130 is also connected via another valve 120 to a GSE gas line 132, which terminates in a nozzle 124. In the same way as for the refuel connector 116, nitrogen indicated by lines 126 is distributed out of the GSE gas line nozzle 124 into the vicinity of the GSE 110. Again, it will be appreciated that there may be many GSE gas lines 132 and respective nozzles 124 spraying areas around the GSE 110, but only one is illustrated here for clarity.

In operation, the nitrogen 126 supplied by the NGS 118 and GSE nitrogen supply 130 is supplied to their respective nozzles 124. Therefore, in the event of a hydrogen leak from the refuel connector 126, or around the GSE 110, there will be a reduced quantity of oxygen present compared to typical air conditions. Additionally, the leaked hydrogen will be dispersed and will not gather in high concentrations. This prevents ignition of hydrogen in the event of a leak. However, there may be a failure case associated with this apparatus, where the nitrogen supply 130 on the GSE 110 provides a single point of failure. It has been recognized that it would be beneficial for the aircraft 100 (in FIG. 1) to still have a functioning ignition protection system for both itself and nearby GSE 110, in the event of failure or exhaustion of the supply 130, or lack of nitrogen supply at a particular airport.

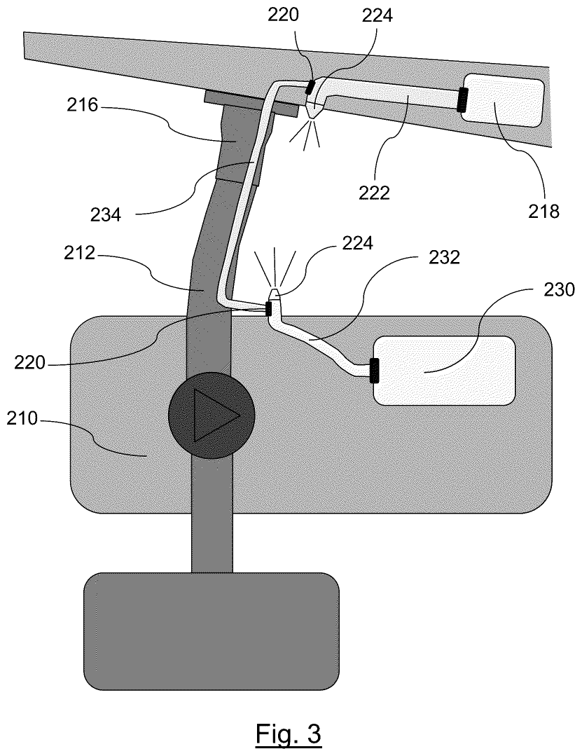

FIG. 3 shows an apparatus for refuelling and defuelling an aircraft with liquid hydrogen according to a first embodiment of the disclosure herein. For conciseness, only those elements which have changed (in comparison to the FIG. 2 example) will be detailed here. Similar 3-digit reference numbers are used, but starting with a “2” in place of a “1”. The last two digits are intended to refer to similar items, in the different embodiments, unless otherwise stated. Likewise, the leading digits of reference numerals in further embodiments are incremented by 1.

The aircraft gas line 222 has a valve 220 placed upstream (in the direction of gas flow) of the aircraft gas line nozzle 224 relative to the NGS 218. This valve 220 connects to an interconnecting gas line 234 at one end. The interconnecting gas line 234 is disposed adjacent to the fuel line 212 and refuel connector 216. At the other end of the interconnecting gas line 234, the interconnecting gas line 234 is connected via a valve 220 to the GSE gas line 232. The interconnecting gas line is stored on the aircraft for deployment. In this way, nitrogen can be supplied from the NGS 218 to the GSE gas line 232, and out the nozzle 224 on the GSE. It will be appreciated that there are other possible positions on the GSE 210 for the interconnecting gas line 234 to connect to, such as the GSE nitrogen supply 230. Therefore, should the nitrogen supply 230 on the GSE 210 fail or be depleted, then the NGS 218 located on the aircraft (not visible) can take over, ensuring supply of nitrogen gas to both the area around the refuel connector 216 and the area around the GSE 210.

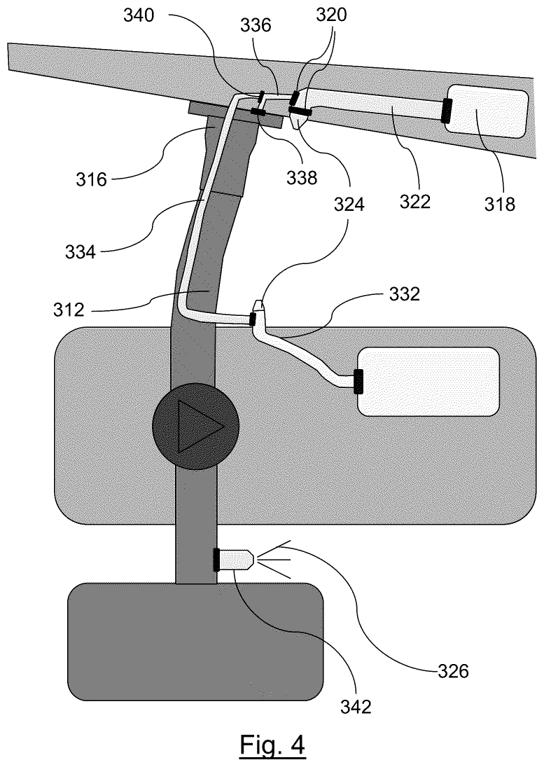

FIG. 4 shows an apparatus for refuelling and defuelling an aircraft with liquid hydrogen according to a second embodiment of the disclosure herein. For the purposes of clarity, only those elements which are different from the elements in the Figures described above will be described.

The aircraft gas line 322 has a valve 320 placed upstream of the aircraft gas line nozzle 324 relative to the NGS 318. This valve 320 connects to a manifold 336. There are two additional valves connected to the manifold. The first additional valve 338 leads to the fuel line. The second additional valve 340 leads to the interconnecting gas line 334. Distributing nitrogen through the interconnecting gas line 334 functions in the same way as in the first embodiment, except that the second valve 340 is required to be open.

When gas is being distributed into the manifold 336, and the first additional valve 338 is open, nitrogen gas is distributed into the fuel line 312 via a nozzle (not visible). The nitrogen gas travels down the fuel line and flushes out any combustible or otherwise undesired (gaseous) elements which may be present from a previous operation, such as oxygen. This is done prior to fuelling or defuelling the aircraft with liquid hydrogen as a precautionary measure. There may be a gas line disposed within the fuel line, with several outlets for dispersal of gas. This gas line may connect to the gas manifold 336.

There is also a nozzle 342 disposed downstream of the first additional valve 338, with the purpose of allowing the nitrogen to exit the fuel line. It will be appreciated that the positioning of the nozzle 342 may vary depending on the type of refuel/defuel bowser or tanker being used, or there may be multiple nozzles positioned along the fuel line 312 depending on how much of the fuel line 312 requires flushing out. In FIG. 4, the case where nitrogen is being passed through the fuel line is displayed. However, in the additional and/or alternative case where valve 338 is closed and valve 340 is open, nitrogen passes from the aircraft to the GSE gas line 332 via the interconnecting gas line 334 to be distributed out of the respective nozzle 324. Note that there is an additional valve 320 before the nozzle 324 associated with the refuel connector 316 in FIG. 4. This allows nitrogen to be selectively flushed through the fuel line 312 without necessarily dispersing it out of the nozzle 324 associated with the refuel connector 316. It will be appreciated that the exact placement and number of valves is not fundamental to the disclosure herein disclosed within-they simply allow for selective and controlled dispersal of the nitrogen.

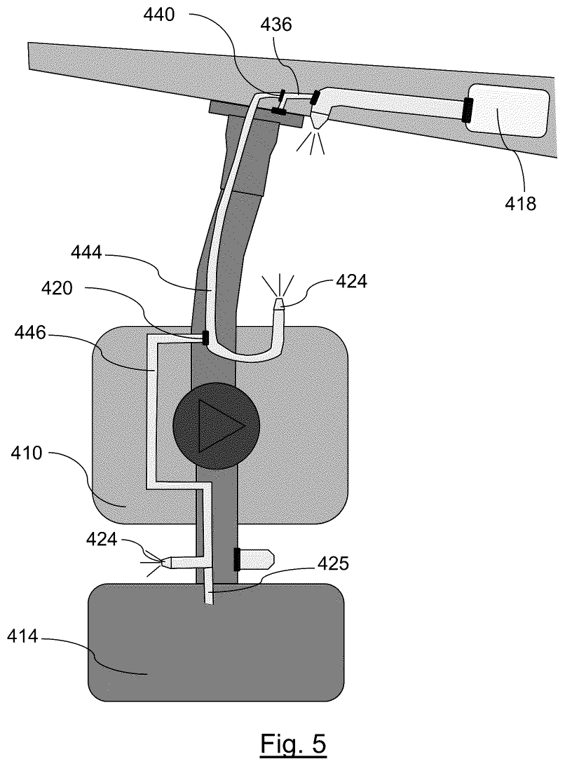

FIG. 5 shows an apparatus for refuelling/defuelling an aircraft with liquid hydrogen according to a third embodiment of the disclosure herein. For the purposes of clarity, only those elements which are different from the elements in the Figures described above will be described.

In this embodiment, there is no supply of inert gas located on the GSE 410. This may be the case in smaller or more remote airports, where they may not have GSE 410 fitted with inerting systems for hydrogen fuel. In this case, the NGS 418 on the aircraft is the only supply of inert gas for the GSE 410. The gas manifold 436 connects through a valve 440 to a deployable aircraft gas line 444 which terminates in a nozzle 424. In use, this deployable gas line 444 is stored on the aircraft and can be deployed for use when needed. It is fastened to the GSE 410 via a suitable fixing structure (not shown). Therefore, the GSE 410 does not need to have a specialized gas distribution and storage system, but simply a way to fasten and direct a gas line.

It will be appreciated that the deployable gas line 444 illustrated in FIG. 5 only has one nozzle 424 for ease of understanding, but it may furcate into multiple gas lines each with a respective gas line nozzle, to disperse inert gas over more areas.

The apparatus in FIG. 5 also includes a fuel reservoir gas line 446 connected via a valve 420 to the deployable aircraft gas line 444. This fuel reservoir gas line 446 terminates in a nozzle 424. The positioning of the nozzle 424 is configured to direct nitrogen gas into the area around the fuel reservoir at the airport. In the case of using a refuel/defuel tank, the nozzle 424 would be configured to direct nitrogen gas into the area around the fuel tank on the GSE. It may also be the case that the nitrogen from the NGS can be used to supply inerting gas to a space within the fuel store 414 (illustrated schematically by gas line 425, which would include a control valve not shown). The fuel reservoir gas line 446 is stored on the aircraft. Again, it will be appreciated that the fuel reservoir gas line 446 may furcate into many gas lines and respective gas line nozzles, to protect a larger area. It will also be appreciated that the reservoir gas line could be a component inbuilt to the GSE, just without a GSE supply of inert gas.

In this way, the aircraft is able to provide all the required apparatus to mitigate the risk of hydrogen ignition in the event of a hydrogen leak from any location from the fuel reservoir at the airport to the refuel port on the aircraft.

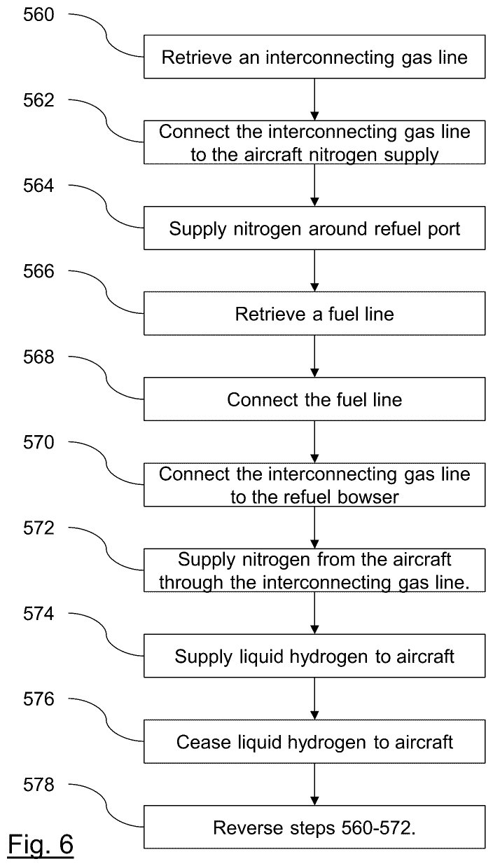

FIG. 6 shows a flow diagram illustrating a method according to a fourth embodiment of the disclosure herein, which could utilize the apparatus of any of the previous embodiments. The method is performed in respect of GSE refuelling or defuelling an aircraft. The refuelling case is covered in this example, but it will be appreciated that defuelling is also possible with the below method, by reversing the direction of fuel supply flow.

The method comprises a step of retrieving 560 an interconnecting gas line. This is stored on the aircraft, but could also be stored elsewhere, such as in the airport or on an item of GSE.

The method further comprises the step of connecting 562 a first end of the interconnecting gas line to a supply of nitrogen on the aircraft. This connection may be made via a network of gas lines and manifolds.

The method further comprises the step of supplying 564 nitrogen from the aircraft supply of nitrogen to at least one nozzle configured to direct nitrogen into the vicinity of a refuel port of the aircraft. This flushes out oxygen around the refuel port and prepares the refuel port for safe connection with the refuel connector. The step of supplying nitrogen to inert the surrounding area (step 564) is always carried out prior to any refuel/defuel.

The method further comprises the step of retrieving 566 a fuel line for connection to the aircraft. This fuel line is located on a refuel bowser.

The method further comprises the step of connecting 568 the fuel line to the aircraft, by connecting the refuel connector to the refuel port. The connector is connected by pushing the refuel connector onto the corresponding connection point, and then rotating the refuel connector about its axis to lock it in place. Note, that this does not establish fluid communication between the fuel line and the refuel connector, so no hydrogen is supplied to or from the aircraft.

The method further comprises connecting 570 a second end of the interconnecting gas line to the refuel bowser. This step comprises connecting the interconnecting gas line to a gas line on the refuel bowser. The refuel bowser gas line divides into multiple gas lines, each terminating in a respective gas line outlet positioned about relevant areas of the refuel bowser, such as the pump. A relevant area is an area where there is greater potential for hydrogen leaks e.g. owing to a connection point, and/or an area where a leak of hydrogen, even if very unlikely, would have more serious consequences.

The method further comprises a step of supplying 572 nitrogen from the aircraft, through the interconnecting gas line, into the vicinity of the refuel bowser. More specifically, nitrogen is dispersed about the above-mentioned relevant areas. This has the effect of both dispersing any flammable or undesirable gases, such as oxygen, present in those locations, dispersing any potentially leaked hydrogen, and creating a high concentration of nitrogen in the region. This reduces the chance of combustion of hydrogen in the event of a leak, as oxygen is not present, and there is no longer a sufficient concentration of hydrogen to ignite.

The method further comprises a step of supplying 574 liquid hydrogen to the aircraft as fuel. This step first involves establishing fluid communication between the fuel line and the aircraft. Fluid communication is established by depressing a valve (not shown) on the refuel connector, such that fluids can pass via the connector from one side of it to the other. Once this is done, liquid hydrogen is pumped by the refuel bowser through the fuel line and into the aircraft. Note, nitrogen is continuously distributed during this step.

The method further comprises a step of ceasing 576 the supply of liquid hydrogen to the aircraft. This may comprise turning off the pump on the refuel bowser, and then elevating a valve on the refuel connector to terminate fluid communication between the fuel line and the aircraft.

The method further comprises performing 578 the inverse of the above steps 560-572, performed in the inverse order to disassemble the equipment. This comprises, after a period of time has elapsed after cessation of the liquid hydrogen supply, ceasing the supply of nitrogen through the interconnecting gas line. The interconnecting gas line is then disconnected from the refuel bowser and then the fuel line is disconnected from the aircraft. Disconnecting the fuel line comprises rotating the refuel connector about its longitudinal axis, in the opposite direction to the direction used for attaching, to unlock the refuel connector. Then, the refuel connector is pulled away from the refuel port. A period of time is provided to allow for any excess hydrogen in the area to be dissipated by nitrogen before continuing the method. The method further comprises storing the fuel line on the refuel bowser. After a period of time has passed after disconnecting the fuel line from the aircraft, the supply of nitrogen to the area around the refuel port is stopped. The interconnecting gas line from the aircraft inert gas supply may then be disconnected for storing back on the aircraft.

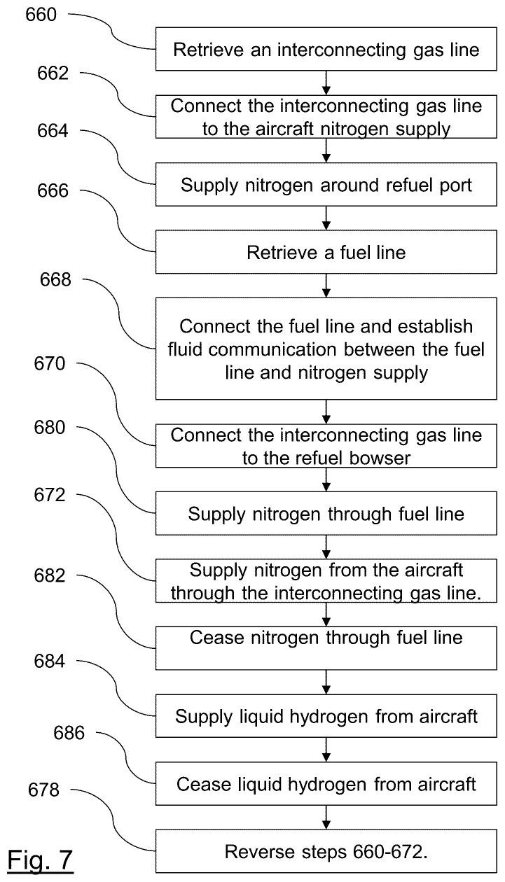

FIG. 7 shows a flow diagram illustrating a method according to a fifth embodiment of the disclosure herein, which could utilize the apparatus of the second and/or third embodiments, and/or could incorporate the method of the fourth embodiment. The method is performed in respect of GSE refuelling or defuelling an aircraft. In this example, the defuelling case is covered, but it will again be appreciated that refuelling is also possible with the below method, simply by changing the direction of fuel supply flow.

Method steps 560-566 of FIG. 6 are carried out as above (relabelled as steps 660 to 666 in FIG. 7). Again, the step of supplying nitrogen to inert the surrounding area (step 664) is always carried out prior to any refuel/defuel and before any connection or disconnection of the fuel lines. The step of connecting 668 the fuel line in this fifth embodiment further comprises establishing fluid communication between the fuel line and the aircraft supply of nitrogen gas, for example through a gas line on the aircraft with a nozzle positioned to distribute nitrogen into the fuel line.

Step 670 is then carried out as per step 570 described above.

The method further comprises a step of distributing 680 nitrogen into the fuel line. There is an outlet downstream of the nozzle allowing nitrogen to exit the fuel line. The outlet opens when nitrogen is being passed through the fuel line. This step flushes out the fuel line with nitrogen such that the quantity of any flammable material such as oxygen present in the fuel line is significantly reduced. This reduces risk of ignition for when liquid hydrogen is passed through the fuel line.

The step 672 is then carried out as per step 572 described above. This step can be done concurrently with supplying 680 nitrogen through the fuel line.

The method further comprises the step of ceasing 682 the supply of nitrogen through the fuel line. This step further comprises the downstream outlet closing, thus preventing any outside air entering the fuel line after the nitrogen supply ends. This step further comprises closing a valve which terminates fluid communication between the fuel line and the nitrogen supply. This is in preparation for supplying hydrogen through the fuel line, and is performed to reduce the risk of hydrogen entering the nitrogen supply.

There is then a step of supplying 684 liquid hydrogen from the aircraft. This may be carried out in substantially the same way as step 574 above, except liquid hydrogen is flowing from the aircraft to the refuel bowser. There is then a step of ceasing 686 the supply of liquid hydrogen from the aircraft. This may be carried out in substantially the same way as step 576 above, except liquid hydrogen is ceased from flowing from the aircraft to the refuel bowser.

There is then a step of performing 678 the inverse of the steps 660-672 above. This involves ceasing the supply of nitrogen through the interconnecting gas line, disconnecting the interconnecting gas line from the refuel bowser, disconnecting the fuel line from the aircraft, storing the fuel line, ceasing the supply of nitrogen to around the refuel port, disconnecting the interconnecting gas line from the aircraft nitrogen supply, and storing the interconnecting gas line on the aircraft. The supply of inert gas through the fuel line, step 680, has been ceased, and hence no inverse is given here.

While the disclosure herein has been described and illustrated with reference to particular embodiments, it will be appreciated by those of ordinary skill in the art that the disclosure herein lends itself to many different variations not specifically illustrated herein. By way of example only, certain possible variations will now be described.

It will be appreciated that the GSE may use inert gas from a central reservoir rather than having an onboard tank.

The interconnecting gas line may be incorporated with the fuel line, i.e. it may be housed within a structure which also houses the fuel line. Connection of the fuel line to the aircraft may automatically establish fluid communication between the interconnecting gas line and the aircraft supply of nitrogen.

The steps of the methods described could be carried out in a different order and/or with one step overlapping another step or being carried out simultaneously.

The method of the fifth embodiment may comprise supplying nitrogen through the fuel line both before and after supplying liquid hydrogen through the fuel line.

Where in the foregoing description, integers or elements are mentioned which have known, obvious or foreseeable equivalents, then such equivalents are herein incorporated as if individually set forth. Reference should be made to the claims for determining the true scope of the disclosure herein, which should be construed so as to encompass any such equivalents. It will also be appreciated by the reader that integers or features of the disclosure herein that are described as preferable, advantageous, convenient or the like are optional and do not limit the scope of the independent claims. Moreover, it is to be understood that such optional integers or features, while of possible benefit in some embodiments of the disclosure herein, may not be desirable, and may therefore be absent, in other embodiments.

The term ‘or’ shall be interpreted as ‘and/or’ unless the context requires otherwise.

It should be understood that modifications, substitutions, and alternatives of the invention(s) may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An apparatus for supplying gas from an aircraft to ground equipment, the apparatus comprising;
a gas supply housed within the aircraft; and
at least one gas line configured to establish fluid communication between the gas supply and the ground equipment.

2. The apparatus of claim 1, wherein gas within the gas supply on the aircraft is generated by a component on the aircraft.

3. The apparatus of claim 2, wherein the component on the aircraft for generating the gas in the gas supply is a nitrogen generation system.

4. The apparatus of claim 1, wherein the at least one gas line comprises at least one outlet, configured to distribute gas for inerting a region or space.

5. The apparatus of claim 1, wherein the at least one gas line is configured to establish fluid communication upon connection of a fuel line to the aircraft.

6. The apparatus of claim 4, wherein the at least one gas line is configured to establish fluid communication upon connection of a fuel line to the aircraft, and wherein the at least one outlet is disposed within the fuel line.

7. The apparatus of claim 5, wherein the fuel line comprises a further outlet downstream of the gas line outlet, the further outlet being configurable between an open and closed configuration.

8. The apparatus of claim 1, wherein the at least one gas line connects to a gas line of the ground equipment.

9. The apparatus of claim 1, wherein the gas line comprises at least one outlet that is configured to be disposed in a vicinity of the ground equipment.

10. The apparatus of claim 1, wherein the gas line comprises at least one outlet that is configured to be disposed in a vicinity of an airport store of fuel.

11. The apparatus of claim 1, wherein the gas line comprises at least one outlet that is configured to be disposed in a vicinity of a refuel connector where the refuel connector provides a fuelling connection at the aircraft.

12. The apparatus of claim 1, wherein the ground equipment is configured to supply liquid hydrogen to the aircraft.

13. The apparatus of claim 1, wherein the ground equipment is a refuel/defuel bowser or a refuel/defuel tanker.

14. A method of refuelling/defuelling an aircraft fuelled with liquid hydrogen, the method comprising:
supplying inert gas from the aircraft to ground support equipment via a fuel line; and
supplying liquid hydrogen to/from the aircraft from/to the ground support equipment via the fuel line.

15. The method of claim 14, wherein the inert gas is generated by a system on the aircraft.

16. A method of protecting against ignition of fuel, the method comprising:
generating inert gas on an aircraft;
supplying the inert gas from the aircraft to ground support equipment; and
distributing inert gas out of at least one outlet, the outlet being arranged to direct the inert gas into a vicinity of the ground support equipment.

17. A method of protecting ground support equipment against ignition of fuel, the method comprising:
supplying, into a vicinity of the ground support equipment, inert gas from a supply of inert gas; and
implementing the method of claim 16 to protect against ignition of fuel in an event of failure of the supply of inert gas.

18. The method of claim 16, wherein the fuel is liquid hydrogen.

19. A method of protecting against ignition of hydrogen during a refuelling/defuelling process, the method comprising:
refuelling/defuelling the aircraft according to claim 14; and
during supplying liquid hydrogen to/from the aircraft from/to the ground support equipment, protecting against ignition of hydrogen fuel by a method comprising:
generating inert gas on an aircraft;
supplying the inert gas from the aircraft to ground support equipment; and
distributing inert gas out of at least one outlet, the outlet being arranged to direct the inert gas into a vicinity of the ground support equipment.

20. An aircraft incorporating the apparatus of claim 1.

21. The aircraft according to claim 20, wherein the aircraft includes a system for generating inert gas for use within a system on the aircraft and a port at an exterior of the aircraft for connecting a gas line to the port for transporting the inert gas from the gas supply on the aircraft to an item of ground support equipment.

22. A refuelling/defuelling system for a hydrogen-powered aircraft, the system comprising;
a fuel line for supplying cryogenic hydrogen to the aircraft;
a supply of inert gas housed within the aircraft; and
a gas line establishing fluid communication between the supply of inert gas and a plurality of inert gas outlets associated with an item of ground support equipment, such that in use inert gas is supplied from the aircraft to the outlets.
